(19) United States
(12) Patent Application Publication
(10) Pub. No.: US 2025/0240691 A1
(43) Pub. Date: Jul. 24, 2025

(54) RESELECTING A NEW SERVING CELL BY A UE

(71) Applicant: CANON KABUSHIKI KAISHA, Tokyo (JP)

(72) Inventors: Pierre VISA, Rennes (FR); Yacine EL KOLLI, Rennes (FR); Walaa SAHYOUN, Rennes (FR)

(21) Appl. No.: 18/853,690

(22) PCT Filed: Mar. 30, 2023
(86) PCT No.: PCT/EP2023/058390

§ 371 Date: Oct. 2, 2024

(30) Foreign Application Priority Data
Apr. 7, 2022 (GB) 2205140.3

(51) Int. Cl. H04W 36/24; H04W 4/06; H04W 36/00; H04W 36/08; H04W 36/36

(52) U.S. Cl. CPC H04W 36/24; H04W 4/06; H04W 36/0007; H04W 36/08; H04W 36/36

(57) ABSTRACT

A method for reselecting, by a User Equipment, UE, a new serving cell of a wireless communication system is disclosed. The method at the UE comprises receiving, from a serving base station of the UE as part of a Multicast Broadcast Service, MBS, procedure for receiving a multicast MBS session, multicast MBS information for one or more candidate cells, selecting one of the one or more candidate cells as a new serving cell for the UE based on the received multicast MBS information. The UE may be operating in a non-connected RRC state and participating in one or more Multicast Broadcast Service, MBS, sessions.

### FIELD OF THE INVENTION

The present invention generally relates to reselecting a new serving cell by User Equipment (UE) and particularly to methods and device for reselecting, by a UE, a new serving cell of a wireless communication system. Cell reselection by a UE may be used when handling mobility of the UE receiving Multicast/Broadcast Service (MBS) in 5G New Radio (NR) systems.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations.

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

Among the requirements for 5G NR, there are service requirements related to multicast and broadcast service, abbreviated as MBS.

For broadcast communication service, the same service and the same specific content data are provided simultaneously to all UEs in a geographical area (i.e. all UEs in the broadcast service area are authorized to receive the data). A broadcast communication service is delivered to the UEs using a broadcast session. For multicast communication service, the same service and the same specific content data are provided simultaneously to a dedicated set of UEs (i.e., not all UEs in the multicast service area are authorized to receive the data). A multicast communication service is delivered to the UEs using a multicast session.

The support of multicast/broadcast techniques enable the network to operate in a more efficient manner than unicast. The identified use cases that could benefit from this MBS feature include public safety and mission critical, V2X applications, IPTV, live video, software delivery over wireless and IoT applications. 3GPP started to build functional support of MBS in 5G NR with Release 17.

In 5G NR, Radio Resource Control (RRC) protocol operates in the control plane between a UE and a base station (gNB), and provides 3 different states for a UE as defined in the 3GPP specifications TS 38.331: RRC_CONNECTED, RRC INACTIVE, and RRC_IDLE states. At power up, a UE is in RRC_IDLE state, and the UE changes to RRC_CONNECTED state upon an RRC connection establishment with a gNB. If the RRC connection is released then the UE changes back to RRC_IDLE state. When in RRC_CONNECTED state, the RRC connection can be suspended by the gNB, and the UE moves to RRC_INACTIVE state. When the UE is in RRC_INACTIVE state it cannot communicate with the 5G system, but both the gNB and the UE keep track of the RRC connection context. Thus, the transition back to the RRC_CONNECTED state from the RRC INACTIVE state is faster than the RRC connection establishment from RRC_IDLE to RRC_CONNECTED state.

With the 3GPP Release 17, the reception of MBS broadcast by a UE is allowed when the UE is in RRC_IDLE, RRC_INACTIVE, or RRC_CONNECTED state, and the reception of MBS multicast is allowed when the UE is in RRC_CONNECTED state only. For the Release 18, the plan is to further allow the MBS multicast reception when the UE is in RRC INACTIVE state. See, for example, 3GPP RP-213568 entitled “New WID: Enhancements of NR Multicast and Broadcast Services” submitted by CATT and entitled (3GPP TSG RAN Meeting #94-e, source CATT), section 3. The objective is to enable a large density of UEs to be receiving MBS multicast data from one cell. Indeed, having UEs in RRC_INACTIVE state leads to a downsize in the control plane footprint of the overall UEs, and thus allows the gNB to handle more UEs. Besides, with many UEs in RRC_CONNECTED state in a cell, there is a risk of uplink congestion, and to always keep UEs in RRC_CONNECTED state is not power efficient. As a result, the advantages of also supporting multicast for UEs in RRC_INACTIVE state have been recognised.

The establishment of a MBS session in a UE can be performed when the UE is in RRC_CONNECTED state. The UE may then be set to RRC_INACTIVE state by the serving gNB while still receiving the MBS data. However, one issue with a UE receiving MBS multicast or broadcast in RRC_INACTIVE state, is the handling of mobility, where a mobile UE is moving from one cell managed by a source gNB to another cell managed by a target gNB, with the aim to maintain the continuity of service (or at least to minimize the data loss). The mobility procedure to migrate from one cell to another depends on the UE's RRC state. In RRC_CONNECTED state, the mobility procedure is called handover and it is triggered by the source gNB based on the measurement reports provided by the UE. With the handover procedure, the network (i.e. the source gNB, the target gNB and the 5G core network (5GC)) controls the procedure to ensure the delivery of MBS data through the target gNB. In RRC_INACTIVE state (and in RRC_IDLE state), the mobility procedure is called cell reselection, and it is managed by the UE itself. In the cell reselection process, a UE periodically evaluates the radio conditions and selects a suitable cell for camping on.

As there is no communication with the network in the cell reselection process, several issues may prevent a UE from continuing to receive the MBS data after cell reselection. First, the UE may select a target gNB that is out of the MBS service area, thus the target gNB is not a base station able to deliver the MBS service the UE is interested in. When the target gNB can provide the same MBS service, another issue for the UE is to get the configuration information to receive the MBS data. One solution could be to switch the UE in RRC_CONNECTED state and to apply the handover procedure. However, this would remove the benefits of keeping the UE in RRC_INACTIVE or RRC_IDLE state (e.g. as discussed above).

For MBS broadcast, the 3GPP Release 17 provides some solutions to enable a UE to stay in RRC_INACTIVE or RRC_IDLE state and to continue receiving MBS broadcast service after cell reselection. Actually, MBS broadcast configuration information is provided on MBS Control Channel (MCCH). MCCH carries the MBSBroadcastConfiguration message which indicates the MBS broadcast sessions that are provided in the cell as well as the corresponding scheduling related information for these sessions. Optionally, the MBSBroadcastConfiguration message may also contain a list of neighbor cells providing the same broadcast MBS service(s) as provided in the current cell. The MCCH information (i.e. information transmitted in messages sent over MCCH) is transmitted periodically, using a configurable repetition period and within a configured transmission window. The configuration information required by the UE to receive MCCH is provided in a System Information Block (SIB) broadcasted to all UEs. Additionally, another SIB broadcasted to all UEs also provides an information related to service continuity of MBS broadcast, i.e. the mapping between frequency and MBS services. Based on the list of neighbor cells providing the same broadcast MBS service(s), a UE can select a suitable cell in the cell reselection process. Then, based on the configuration information broadcasted in the target cell, the UE can configure its user plane to continue receiving the MBS broadcast data. However, these solutions for MBS broadcast cannot be reused for MBS multicast. As an MBS multicast service may be reserved to a restricted set of UEs having the authorization to receive it (e.g. a particular multicast group), all the configuration information for MBS multicast reception cannot be made available to all UEs like for MBS broadcast.

Accordingly, it is desirable to provide solutions, for example for a UE receiving MBS multicast in a non-connected state, to ensure continuity of MBS service is maintained or at least data loss is minimised on cell reselection performed by a UE.

### SUMMARY

In accordance with a first aspect of the present invention, there is provided a method for reselecting, by a User Equipment, UE, a new serving cell of a wireless communication system. The method at the UE comprises: receiving, from a serving base station of the UE, load information indicating load status of one or more candidate cells; selecting one of the one or more candidate cells as a new serving cell for the UE based on the received load information.

The UE may be operating in a non-connected RRC state (e.g. RRC_INACTIVE state) and participating in one or more Multicast Broadcast Service, MBS, sessions (e.g. one or more MBS multicast sessions).

By using load information to select the new serving cell, the UE can avoid selecting a cell that is overloaded as the new serving cell. For a UE participating in one or more MBS sessions (e.g. receiving MBS multicast data), this helps to ensure the continuity of MBS service and minimize loss of data.

For example, to handle mobility for a UE receiving MBS multicast in RRC_INACTIVE state, the target gNB should be informed of a new UE in RRC_INACTIVE state willing to receive an MBS service. This helps to ensure that the UE is authorized to receive the MBS multicast, and for the target gNB to provide the UE with the configuration information to receive the MBS service in the new cell, and if needed, to request the core network to provide the MBS data to the target gNB. To perform these actions, the target gNB will need to have some resources available, which is not the case if the target gNB is overloaded. If a UE, when executing the cell reselection process, selects a target gNB that is overloaded, the continuity of MBS service may not be maintained (or at least data will be lost). Hence, by using load information to select the new serving cell, the UE can avoid selecting a cell that is overloaded as the new serving cell.

The method may further comprise receiving, from the serving base station, Multicast Broadcast Service, MBS, information, the MBS information indicating whether the one or more candidate cells can support a MBS service for the UE. In this example, selecting one of the one or more candidate cells as a new serving cell for the UE comprises selecting one of the one or more candidate cells as a new serving cell for the UE based on the received load information and the received MBS information.

By using load information and MBS information to select the new serving cell, the UE can avoid selecting a cell that cannot support the MBS session(s) for the UE and/or is overloaded as the new serving cell. For a UE participating in one or more MBS sessions (e.g. receiving MBS multicast data), this helps to ensure the continuity of MBS service and minimize loss of data.

In accordance with a second aspect of the present invention, there is provided a method for reselecting, by a User Equipment, UE, a new serving cell of a wireless communication system. The method at the UE comprises: receiving, from a serving base station as part of a Multicast Broadcast Service, MBS, procedure for establishing a MBS session, MBS information for one or more candidate cells, the MBS information for a candidate cell indicating whether the respective candidate cell can support a MBS service for the UE; selecting one of the one or more candidate cells as a new serving cell for the UE based on the received MBS information.

By using the MBS information to select the new serving cell, the UE can avoid selecting a cell that cannot support the MBS session(s) for the UE. For a UE participating in one or more MBS sessions (e.g. receiving MBS multicast data), this helps to ensure the continuity of MBS service and minimize loss of data. Furthermore, by using the MBS information received as part of the MBS session establishment procedure for establishing a MBS session, the MBS information is received once which reduces the processing performed at the UE: the UE does not have to request the MBS information nor receive the MBS information via periodic broadcasts sent by the serving base station.

In accordance with a third aspect of the present invention, there is provided a method at a serving base station controlling a serving cell of a User Equipment, UE which is operating in a RRC_INACTIVE state. The method at the base station comprises: obtaining a load status of one or more candidate cells; sending, to the UE, load information indicating the load status of the one or more candidate cells.

By obtaining the load status and sending the load information indicating the load status to the UE, the serving base station supports the cell reselection of a new serving cell for the UE by providing load information to the UE which the UE can use to select a new serving cell so as to avoid selecting a cell that is overloaded as the new serving cell.

The method may further comprise (e.g. when the UE is participating in one or more Multicast Broadcast Service, MBS, sessions (e.g. one or more MBS multicast sessions)): obtaining MBS information, the MBS information indicating whether the one or more candidate cells can support a MBS service for the UE; sending, to the UE, the MBS information.

By obtaining the MBS information and sending the MBS information to the UE, the serving base station supports the cell reselection of a new serving cell for the UE by providing load information and MBS information to the UE which the UE can use to select a new serving cell so as to avoid selecting a cell that is overloaded as the new serving cell and/or a cell that cannot support the MBS session(s) for the UE.

In accordance with a fourth aspect of the present invention, there is provided a UE as recited in claim 37.

In accordance with a fifth aspect of the present invention, there is provided a base station as recited in claim 38.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments of the invention;

FIG. 2 illustrates a block schematic diagram of an example configuration of a UE in which the present invention may be implemented according to one or more embodiments of the invention;

FIG. 3 illustrates a block schematic diagram of an example configuration of a base station in which the present invention may be implemented according to one or more embodiments of the invention;

FIG. 4 is a flowchart showing the RRC connection states and transitions for a UE in 5G NR systems;

FIG. 5 is a simplified flowchart illustrating the handover procedure while a UE is receiving MBS multicast data in RRC_CONNECTED state;

FIG. 6 is a flowchart illustrating an example cell reselection procedure for a UE in RRC_INACTIVE state and receiving MBS multicast data, according to an embodiment of the invention;

FIG. 7 is a flowchart illustrating an example cell reselection procedure for a UE in RRC_INACTIVE state and receiving MBS multicast data, according to an embodiment of the invention;

FIG. 8 is a flowchart of a method, performed by a base station, for supporting cell reselection in accordance with embodiments of the invention;

FIGS. 9a and 9b are flowcharts illustrating example methods performed at a UE for cell reselection in accordance with embodiments of the invention;

FIG. 10 is a flowchart of a method, performed by a UE, for reselecting a new serving cell of a wireless communication system in accordance with embodiments of the invention;

FIG. 11 is a flowchart of a method, performed by a UE, for reselecting a new serving cell of a wireless communication system in accordance with embodiments of the invention;

FIG. 12 is a flowchart illustrating an example method performed at a base station for providing information for cell reselection in accordance with embodiments of the invention.

### DETAILED DESCRIPTION

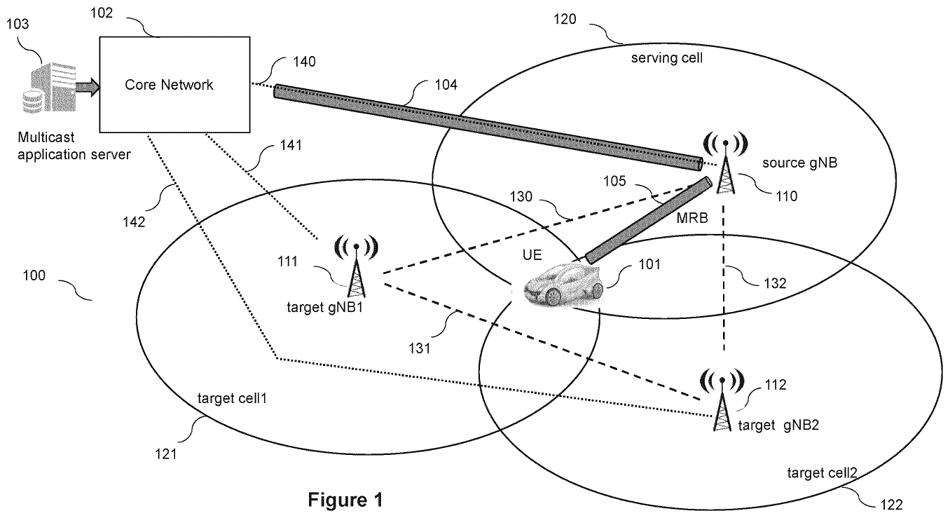

FIG. 1 illustrates an example wireless communication system 100, in particular a mobile radio communication system such as a fifth-generation (5G) New Radio (NR) system supporting multicast and broadcast service (MBS). Although in the following description, embodiments and examples of embodiments of the present invention will be described with respect to a 5G NR system, it will be appreciated that it is not intended that the present invention is limited to 5G NR systems and may be used in any wireless communication systems supporting MBS or similar service.

The system 100 comprises a User Equipment (UE) 101, which may be for instance in or part of a vehicle, served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g. smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, 111 and 112. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110, 111 and 112 are interconnected by means of the Xn interface (specified in the 3GPP document TS 38.423) implemented on the wired or wireless links 130, 131 and 132. Each base station is connected to the core network by means of the NG interface (specified in the 3GPP document TS 38.413) implemented on the wired or wireless links 140, 141 and 142.

Each of these base stations controls one or multiple cells. For instance, the base stations 110, 111, 112 control respectively the cells 120, 121, 122. A cell is a geographical area of a radio network defined by the frequency used in the cell to transmit data. The cell can be uniquely identified by a UE from an identification that is broadcasted over a geographical area. Each base station 110, 111, 112 can serve several UEs like the UE 101. Once a UE has established a RRC connection with a base station (as discussed below), the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Application Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

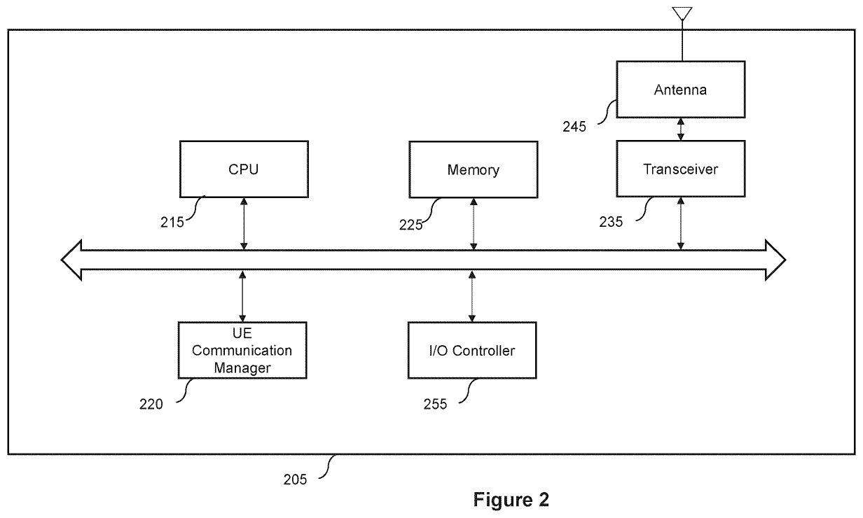

FIG. 2 illustrates a block diagram of a UE device 205, like the UE 101 in the FIG. 1, in which the present invention may be implemented according to one or more embodiments of the invention. The UE includes components for transmitting and receiving communications, including a UE communication manager 220, a I/O controller 255, a transceiver 235, a set of antennas 245, memory 225, and a processor (CPU: Central Processing Unit) 215. All these elements communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, windows, Android, etc. The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc.

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

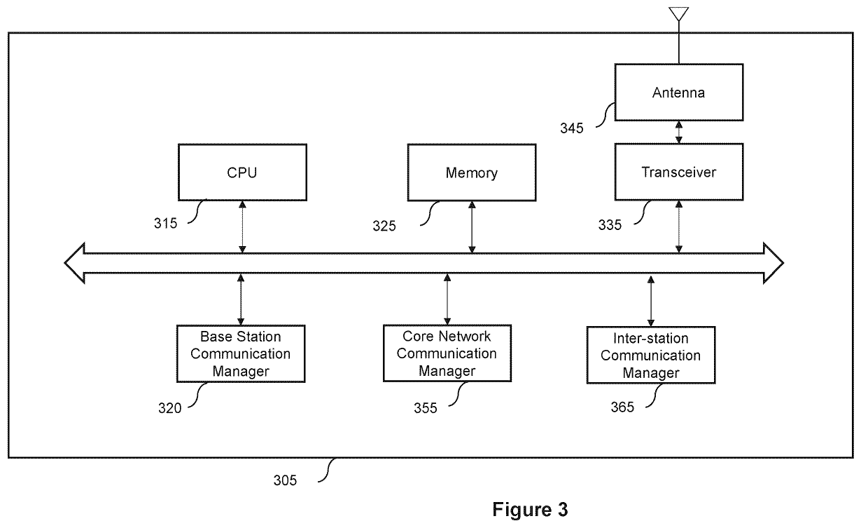

FIG. 3 illustrates a block diagram of a base station device 305, like the base stations or gNBs 110, 111 and 112 in the FIG. 1, in which the present invention may be implemented according to one or more embodiments of the invention. The base station device 305 includes components for transmitting and receiving communications, including a Base Station communication manager 320, a Core Network communication manager 355, a transceiver 335, a set of antennas 345, memory 325, a processor (CPU) 315, and an Inter-Station communication manager 365. All these elements communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The Inter-Station communication manager 365 manages communications with other base stations. The Inter-Station communication manager 365 may provide a standardized Xn interface, as defined by the 3GPP standard, to support these communications.

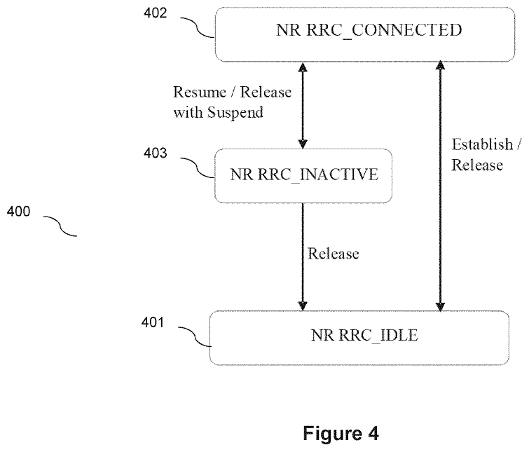

FIG. 4 is a flowchart 400 showing the RRC connection states and transitions for a UE in 5G NR. The RRC protocol operates between a UE and a base station (gNB) and is defined in 3GPP specifications TS 38.331 for 5G NR. The UE's state names are prefixed with “NR” for New Radio. Other prefixes are used for other radio interfaces like LTE radio interface. For the sake of simplicity, the radio technology prefix is omitted in the rest of the description.

Radio Resource Control (RRC) is a layer within the 5G NR protocol stack. It exists only in the control plane, in the UE and in the gNB. The behavior and functions of a base station and a UE are governed by the current RRC state of the UE. In 5G NR, three distinct RRC states are specified for a UE: RRC_IDLE state 401, RRC_CONNECTED state 402 and RRC_INACTIVE state 403.

At power-up the UE is in RRC_IDLE state 401, it performs radio link quality measurements and executes the cell selection evaluation process (as defined in 3GPP specifications TS 38.304 V16.7.0) to identify a target gNB to connect to. The UE state changes to RRC_CONNECTED state 402 upon an RRC connection establishment with the target gNB that becomes the source gNB serving the UE. In the following, the source base station (or source gNB) may also be referred to as the serving base station or serving gNB. If there is no radio activity for a while, the RRC connection can be released by the source gNB, then the UE's RRC state changes back to RRC_IDLE state 401.

While releasing an RRC connection is interesting for capacity utilization and power saving, it is not ideal from the latency perspective. The overhead in establishing an RRC connection requires extra signaling that introduces delay. To cope with this drawback, the RRC_INACTIVE state 403 has been introduced for 5G NR. When the UE is in RRC_INNACTIVE state 403, the UE cannot communicate with the 5G system, but both the source gNB (e.g. last serving gNB) and the UE store the UE context or configuration. The stored UE context or configuration includes information to facilitate quick resumption of the connection. The information may include the security context (e.g. security parameters such as security key, UE security capabilities), measurement configuration, radio configuration (e.g. UE radio capability), information about bearers, PDU session context etc. Thus, when in RRC_CONNECTED state 402, the RRC connection can be suspended by the source gNB (Release with suspend), and the UE moves to the RRC_INACTIVE state 403. From the RRC_INACTIVE state 403, the UE can be switched back to the RRC_CONNECTED state 402 by the gNB (Resume) and the UE applies the stored UE context or configuration. The RRC resume message is sent by a gNB upon reception of a RRC resume request message from the UE.

From either the RRC_CONNECTED state or RRC_INNACTIVE state, the UE can transit to RRC_IDLE state upon a RRC release command received from the gNB.

The mobility procedure to migrate a UE from one cell to another depends on the UE's RRC state. In RRC CONNECTED state, the mobility procedure, called handover, is controlled by the network, and the source gNB takes the decision to trigger the handover procedure based on the measurement reports provided by the UE. In RRC_INACTIVE and in RRC_IDLE states (e.g. non-connected RRC states), the mobility procedure is called cell reselection, and it is managed by the UE itself.

In RRC_INACTIVE state, the UE can be configured by the network with a RAN Notification Area (RNA). For example, the message that transitions the UE to the RRC_INACTIVE state contains information indicating the RNA. The RNA is the area within which the UE can move without notifying the network. When the UE in the RRC_INACTIVE state moves to a cell that is not part of its currently assigned RNA, the UE performs a location-update procedure that enables the RAN (e.g. serving gNB) to update the assigned RNA to the UE. In other words, the UE has the possibility to request an RNA update to be informed of a modification of the RNA. When, as part of the cell reselection process, the UE selects a cell managed by a target gNB out of the RNA, the UE sends a resume request to the target gNB, which has three options available: to keep the UE in RRC_INACTIVE state, to set the UE in RRC_IDLE state, or to set the UE in RRC_CONNECTED state.

In RRC_IDLE state, the paging procedure to inform a UE that it has to resume the connection is initiated by the core network. In RRC_INACTIVE state, the paging procedure is initiated by the NG RAN (i.e. the last gNB that had set the UE in RRC_INACTIVE state).

Back to the FIG. 1, it is assumed that the UE 101 is in the RRC_INACTIVE state and that it is receiving multicast data of one or more multicast MBS sessions generated by the multicast application server 103. The multicast data are provided to the base station 110, which is the serving base station for UE 101, through the core network 102 and the transport bearer 104 over the link 140. Then, the multicast data are transmitted by the base station 110 to the UE 101 through the MBS Radio Bearer (MRB) 105. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

The MBS session join procedure, as specified in 3GPP TS 23.247, is used by UEs to inform the 5GC of an interest in joining a multicast MBS session. The first accepted UE join request triggers the multicast MBS session establishment towards the NG RAN and the UE. Before sending a join request for a multicast MBS session, the UE should have established a

PDU session that can be associated with multicast session(s), using the procedures as specified in TS 23.502. Also, the UE should know at least the MBS Session ID of a multicast group that the UE can join, via service announcement broadcasted by the network. To join the multicast group, the UE sends a PDU Session Modification Request for the associated PDU session which contains one or several MBS Session ID(s) and a join request. The MBS Session ID(s) indicates the multicast MBS session(s) that UE wants to join.

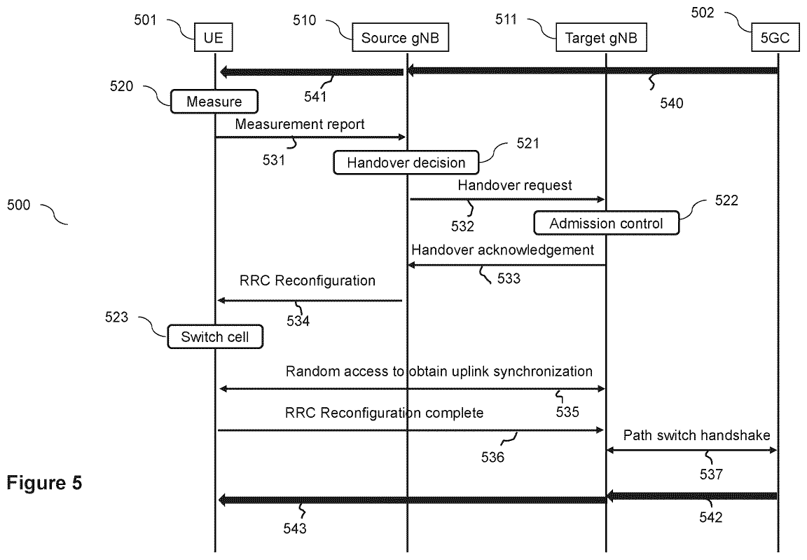

To join an MBS session, the UE has to be in the RRC_CONNECTED state. While receiving MBS multicast data in RRC_CONNECTED state, the UE 101 may have successively moved to different cells using the handover procedure illustrated by FIG. 5.

FIG. 5 is a simplified flowchart 500 illustrating the handover procedure while a UE, such as UE 101 of FIG. 1, is receiving MBS multicast data in RRC_CONNECTED state. This figure shows a UE 501, like the UE 101, a base station 510, like the base station 110 that is the source or serving gNB in the sense that it controls the cell (which may be referred to as a serving cell) where the UE is currently camping, a base station 511, like the base station 111 or 112, controlling a candidate cell where the UE 501 may move, and the core network (5GC) 502, like the core network 102. The MBS multicast data are provided by the 5GC to the source gNB (through the bearer 540), then MBS multicast data are transmitted to the UE 501 (through the radio bearer 541), simultaneously to the other UEs belonging to the same multicast group.

The UE 501 is configured with measurements to perform regularly on cells in the neighborhood. The first step 520, which is continuously executed when in RRC_CONNECTED state, is to search for candidate cells. Once a candidate cell has been found, the UE 501 measures one or more parameters of a signal received from the candidate cell. The parameters may include the reference signal received power (RSRP), or reference signal received quality (RSRQ). For example, the UE 501 measures the reference signal received power (RSRP), or reference signal received quality (RSRQ) typically performed on the Signal Synchronization Block (SSB) transmitted in this candidate cell. Depending on the triggering events configured in the UE, a measurement may trigger a measurement report 531 (RRC protocol message) sent by the UE 501 to the source gNB 510 with information on the candidate cell.

Upon reception of a measurement report 531, the source gNB 510 can decide to perform a handover or not, at the handover decision step 521. Additional information other than the measurement report can be taken into account, such as whether the target gNB controlling the candidate cell or target cell is within the MBS service area and can provide the same MBS service(s) the UE is listening to (e.g. support one or more existing/ongoing MBS session(s) for the UE), and/or whether there is sufficient capacity available in the target cell for the handover). The network may also decide to handover a UE to another cell even if no measurement report has been received, for example for load balancing purposes. If the network decides to handover the UE to another cell, such as the target cell controlled by the target gNB 511 (step 521), the source gNB 510 sends a handover request 532 (Xn protocol message) to the target gNB 511. If the source and target cells belong to the same gNB there is no need for this message as the situation in the target cell is already known by the gNB. The handover request message 532 includes the UE context containing information related to the MBS session(s) the UE has joined. Then, the target gNB 511 performs the admission control step 522 to decide whether to accept or not the handover request. It may reject the request, for instance if the load in the target cell is too high. In any case, the target gNB 511 sends a handover acknowledgment message 533 to the source gNB 510. If the target gNB 511 accepts the handover, the source gNB informs the UE 501 to switch cell through the RRC reconfiguration message 534 containing the necessary information for the UE 501 to access the target cell, such as radio bearer(s), measurement configuration, (information previously received by the source gNB from the target gNB in the acknowledgment message 533). In case of conditional handover (CHO), the UE 501 is configured with a triggering condition to fulfil before switching to the new cell (not shown in FIG. 5).

At step 523, the UE 501 switches to the target cell as the new serving cell and moves the RRC connection to the target gNB 511. To be able to connect to the new serving cell, uplink synchronization is required, therefore the UE typically performs random access 535 towards the target cell to acquire uplink synchronization. Once synchronization is established, the UE sends a RRC Reconfiguration Complete message 535 to the target gNB 511, which is now its new source or serving gNB managing the new serving cell.

In the meantime, the target gNB 511 performs the path switch handshake procedure 537 toward the core network 502 to request the switch of the transport bearer. Thus, the MBS multicast data can be provided by the core network 502 to the target gNB 511 (through the bearer 542), and the MBS multicast data are then transmitted to the UE 101 (through the MBS radio bearer 543), simultaneously to the other UEs belonging to the same multicast group. To minimize or to prevent data loss during the handover operation, any data buffered in the source gNB 510 may be moved to the target gNB 511 (not shown in FIG. 5).

Back again to the FIG. 1, it is assumed that the UE 101 now camps in the cell 120, which is the serving cell for the UE 101 with the base station 110 as the source or serving gNB, and that without radio activity, apart from the reception of MBS multicast data, the UE 101 has been set in RRC_INACTIVE state by the gNB 110. While the UE 101 is still receiving MBS multicast data, it may move and arrive at the edge of the serving cell 120, but also for instance, at the edge of the two other cells 121 and 122. At some point, the UE 101 may need to change the serving cell as it may be soon out of coverage of the cell 120. As the UE 101 is in RRC_INACTIVE state, the UE has to execute the cell reselection process to change the serving cell. Thus, unlike the case where the UE is in the RRC_CONNECTED state and the mobility procedure is handled by the network (RAN and core network) to ensure the delivery of MBS data through the target gNB, in the RRC_INACTIVE state (and in RRC_IDLE state, both of which are non-connected states), the mobility procedure is called cell reselection, and it is managed by the UE itself. When performing cell reselection, the UE executes a cell reselection evaluation process (for example, as described in 3GPP specifications TS 38.304 V16.7.0, section 5.2.4) and there is no communication with the network. As there is no communication with the network in the cell reselection process, several issues may prevent a UE from continuing to receive the MBS data after cell reselection. For example, the UE may select a target gNB that is out of the MBS service area and so cannot support a MBS service the UE is interested in. When the target gNB can provide the MBS service of interest, another issue relates to how does the UE get the configuration information required to receive the MBS data via the target gNB. Thus, to handle mobility for a UE receiving MBS multicast in RRC_INACTIVE state, the target gNB will need to be informed of a new UE in RRC_INACTIVE state willing to receive an MBS service. This helps to ensure that the UE is authorized to receive the MBS multicast, and for the target gNB to provide the UE with the configuration information to receive the MBS service in the new cell, and if needed, to request the core network to provide the MBS data to the target gNB. However, to perform these actions, the target gNB will need to have some resources available, which is not the case if the target gNB is overloaded. For example, if a UE, when executing the cell reselection process, selects a target gNB that is overloaded, the continuity of MBS service may not be maintained (or at least data will be lost). Hence, the UE when executing the cell reselection process should avoid selecting a target gNB that is overloaded.

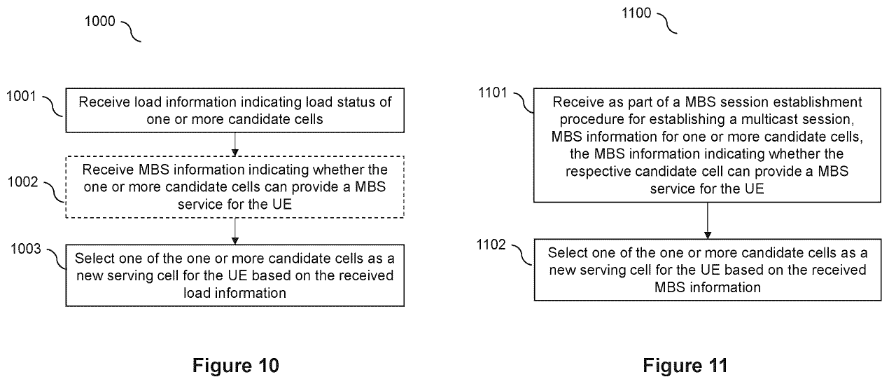

Referring now to FIG. 10 which shows steps of a method 1000 for reselecting a new serving cell of a wireless communication system in accordance with an embodiment of the present invention, which method is performed by a UE. The wireless communication system may be, for example, the wireless communication system 100 of FIG. 1 and the UE may be the UE 101 of FIG. 1 and may comprise the UE 205 of FIG. 2 with the method 1000 being performed by the processor 215. The UE may be in a non-connected RRC state (such as a RRC_INACTIVE state) and may be participating in or joined to one or more multicast MBS session(s) (e.g. one or more active multicast MBS sessions).

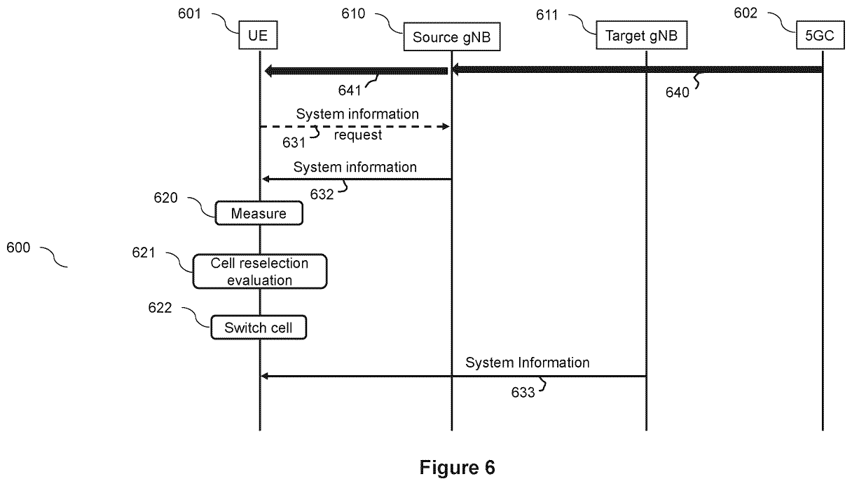

Briefly, at step 1001, the UE 101 receives load information from the base station operating as the source or serving base station for the UE (i.e. the source or serving base station is a RAN node (e.g. base station) that controls the serving cell on which the UE is camped). The load information indicates the load status of one or more candidate cells. For example, the one or more candidate cells may be neighbouring candidate cells to the serving cell or may be candidate cells identified by the UE 101 as suitable cells (e.g. as part of the cell reselection evaluation process as discussed in more detail below with reference to FIG. 6). The load information indicates the load status of each one of the one or more candidate cells. The load status of a candidate cell indicates a level of a load associated with the candidate cell. The load associated with the candidate cell may be a processing load of the base station controlling the candidate cell (e.g. the load of processing resources of the base station) and/or it may be the load of the radio resources (e.g. occupied radio bandwidth) in the candidate cell. In the example shown in FIG. 1 where the UE 101 is camped on the cell 120, the gNB 110 is the serving base station and cell 120 is the serving cell and cells 121 and 122 are candidate cells. The load information may also indicate the load status of the serving cell. The load information for a candidate cell may indicate the level of current load associated with the respective candidate cell. The load information may be a single bit with the value ‘1’ indicating that the processing load of the gNB controlling the cell and/or the radio bandwidth in the cell is at an overloaded level, and the value ‘0’ indicating that the processing load of the gNB and/or the radio bandwidth in the cell is at a not overloaded level or the values reversed with ‘0’ indicating an overloaded level and ‘1’ indicating a non-overloaded level. The load status may be a level coded on several bits (e.g. one of a plurality of levels coded on several bits).

Based on the received load information, the UE selects one of the one or more candidate cells as a new serving cell for the UE, step 1003. For example, the UE selects the candidate cell as the new serving cell with the lowest load as indicated by the load information. If the received load information indicates that all of the candidate cells are overloaded, the UE may repeat the reselection process. The UE may then switch to the new serving cell to camp. Thus, by using load information to select the new serving cell, the UE can avoid selecting a cell that is overloaded as the new serving cell. For a UE participating in one or more MBS sessions (e.g. receiving MBS multicast data), this helps to ensure the continuity of MBS service and minimize loss of data.

As shown in dotted lines in FIG. 10, the method may further include, step 1002, receiving, from the serving base station, MBS information indicating whether the one or more candidate cells can provide or support MBS service for the UE. In other words, whether the one or more candidate cells can support one or more MBS sessions (e.g. one or more MBS multicast or broadcast sessions) that the UE is interested in (such as existing or ongoing MBS session(s) (e.g. active MBS session(s)) and/or MBS session(s) that the UE is interested to receive). The UE may receive MBS information indicating whether the candidate cells can support MBS service for the UE for only one or more candidate cells in the neighbourhood of the serving cell (i.e. for only the neighbouring cells of the serving cell) or may receive MBS information listing all of the cells that can provide or support MBS service for the UE. Based on the received load information and the received MBS information, the UE can select one of the one or more candidate cells as a new serving cell for the UE. For example, when there are more than one candidate cells that can support MBS service for the UE as determined by the MBS information, the UE selects the candidate cell as the new serving cell with the lowest load as indicated by the load information. Thus, by using load information and MBS information to select the new serving cell, the UE can avoid selecting a cell that cannot support the MBS session(s) for the UE and/or is overloaded as the new serving cell. For a UE participating in one or more MBS sessions (e.g. receiving MBS multicast data), this helps to ensure the continuity of MBS service and minimize loss of data.

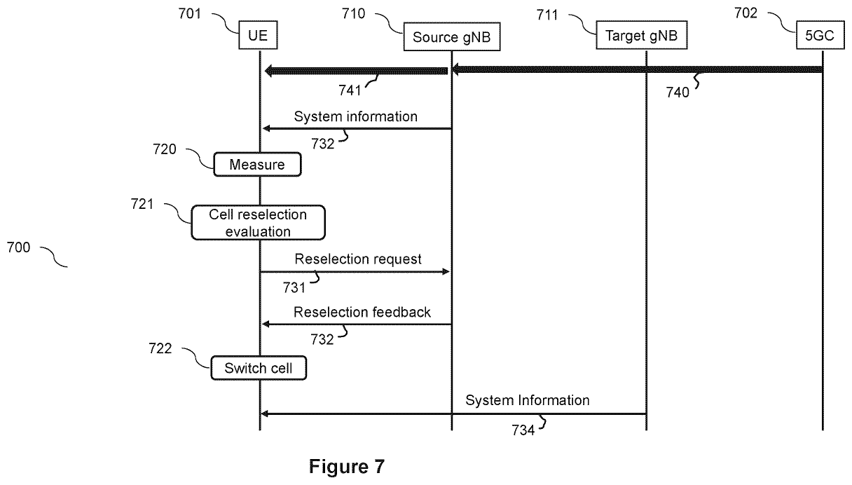

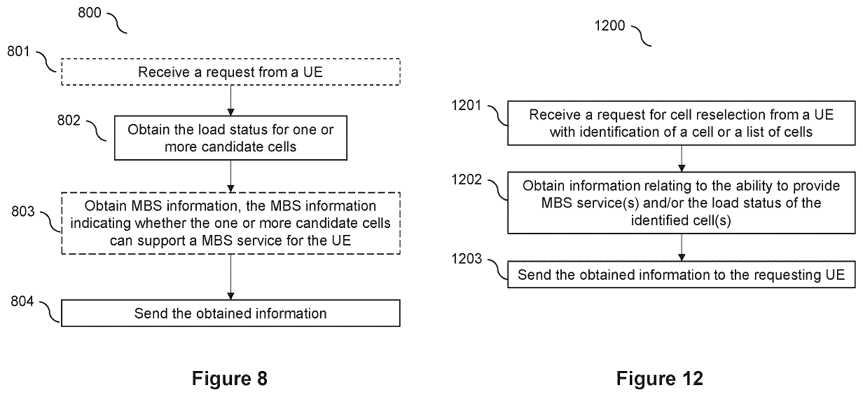

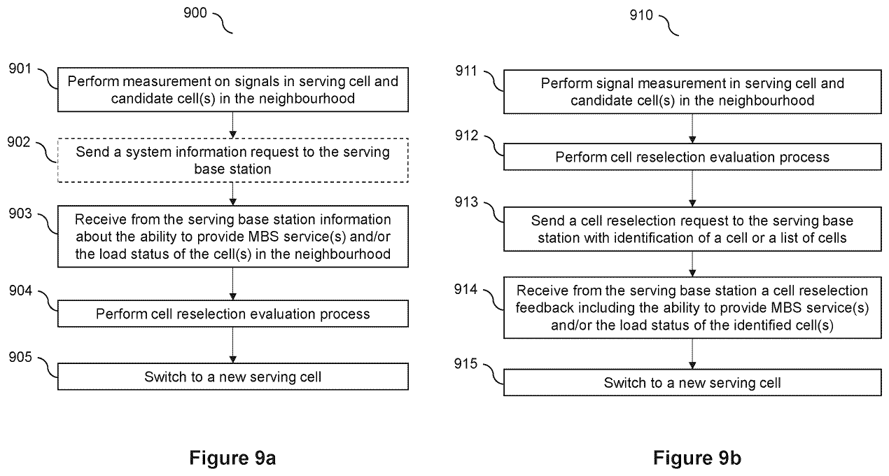

The load information and/or the MBS information may be received in system information sent periodically by the serving base station or in information sent by the serving base station in response to a request sent by the UE to the serving base station. The load information and/or the MBS information may be sent periodically (for example by broadcast) in a System Information Block (SIB) as discussed below. The request sent by the UE may include information for requesting load status of one or more candidate cells and/or for requesting MBS information indicating whether one or more candidate cells can support a MBS service for the UE. The request may include identification information (identifier(s)) for each of one or more candidate cells for which the UE is requesting load status and/or MBS information. The identification information for each candidate cell may include the cell ID and the base station (gNB) ID of the cell. 3GPP TS 38.413 sections 9.3.1.6 and 9.3.1.7 describes the gNB ID being included in the cell ID. The request may also include session identification information (e.g. MBS session identifier(s)) identifying the one or more MBS sessions that the UE is interested in (e.g. existing or ongoing MBS sessions (active MBS session(s))). The request may be a system information request such as the system information request as described in more detail below with reference to FIG. 6 and FIG. 9a. In response to the system information request, the serving base station sends system information to the requesting UE (e.g. in a SIB). Alternatively, the request sent by the UE may be a reselection request such as the reselection request as described in more detail below with reference to FIG. 7, FIG. 8b and FIG. 9b. In response to the reselection request, the serving base station sends reselection feedback to the requesting UE. By including identifiers for more than one candidate cell in the request to the serving base station as opposed to including just one identifier, the UE should receive load and/or MBS information for more than one candidate cell so that if one of the candidate cells is overloaded or doesn't support MBS service, the UE has information to select another candidate cell without having to request additional information from the serving base station. The MBS information may be sent as part of a MBS procedure for establishing a MBS session as discussed below with reference to FIG. 11.

Referring now to FIG. 11 which shows steps of a method 1100 for reselecting a new serving cell of a wireless communication system in accordance with an embodiment of the present invention, which method is performed by a UE. The wireless communication system may be, for example, the wireless communication system 100 of FIG. 1 and the UE may be the UE 101 of FIG. 1 and may comprise the UE 200 of FIG. 2 with the method 1100 being performed by the processor 215. The UE may be in a non-connected RRC state (such as a RRC_INACTIVE state) and may be participating in or joined to one or more MBS session(s) (e.g. one or more active multicast MBS sessions).

Briefly, at step 1101, the UE 101 receives from the serving base station, MBS information indicating whether the one or more candidate cells can provide or support MBS service for the UE. In other words, whether the one or more candidate cells can support one or more MBS sessions (e.g. one or more MBS multicast or broadcast sessions) that the UE is interested in (such as existing or ongoing MBS session(s) and/or MBS session(s) that the UE is interested to receive). The UE 101 receives the MBS information as part of a MBS session establishment procedure for establishing a MBS session (e.g. a MBS multicast session or a MBS broadcast session). The MBS session establishment procedure is described in 3GPP TS 23.247. The MBS information may list all of the cells that can provide or support MBS service for the UE (e.g. a list of identifiers of the cells that can provide or support MBS service for the UE). In an example, the UE 101 may receive the MBS information via a service announcement mechanism such as a service announcement broadcasted by the network during the MBS session establishment procedure.

Based on the received MBS information, the UE selects one of the one or more candidate cells as a new serving cell for the UE, step 1102. For example, the UE selects one of the candidate cells that can support MBS service for the UE as the new serving cell as indicated in the MBS information. The UE may then switch to the new serving cell. If the received MBS information indicates that none of the candidate cells support MBS service for the UE, the UE may repeat the reselection process. Thus, by using the MBS information to select the new serving cell, the UE can avoid selecting a cell that cannot support the MBS session(s) for the UE. For a UE participating in one or more MBS sessions (e.g. receiving MBS multicast data), this helps to ensure the continuity of MBS service and minimize loss of data. Furthermore, by using the MBS information received as part of the MBS session establishment procedure for establishing a MBS session, the MBS information is received once which reduces the processing performed at the UE: the UE does not have to request the MBS information nor receive the MBS information via periodic broadcasts sent by the serving base station.

The selection of the new serving cell according to the example methods shown and described above with reference to FIG. 10 and FIG. 11 may also be based on measurements performed by the UE on signals received at the UE from the one or more candidate cells, such as measurements performed on received Signal Synchronization Block (SSB). Measurements may also be performed on signals received at the UE from the serving cell. The measurements are made to determine signal quality or radio link quality so as to evaluate the radio conditions for communication between the UE and a base station of a cell. Those cells where the radio link quality is above a threshold can be identified as candidate cells that can be considered as suitable cells for reselection. For example, the UE measures one or more parameters, such as the reference signal received power (RSRP), or reference signal received quality (RSRQ), of a signal received from the candidate cell and determines whether the measured parameter is above a threshold. The measurements may be performed before or after receiving the load information and/or the MBS information. For example, once the load information and/or the MBS information is received for a plurality of candidate cells, the UE may identify at least one candidate new serving cell for the UE from the plurality of candidate cells based on the received load information and/or the MBS information and then perform measurements on signals received at the UE from the identified at least one candidate new serving cell. The UE can then select one of the at least one candidate new serving cells as the new serving cell for the UE based on the performed measurements (e.g. select a candidate cell as the new serving cell with the best or one of the best radio link quality as determined from the performed measurements). This means that the UE does not perform measurements for all the candidate cells only those which are not overloaded and/or which can support MBS service. Performing the measurements before receiving the load information and/or the MBS information is discussed in more detail below with reference to FIGS. 9a and 9b. When the UE has been provided with load information, MBS information and signal quality information for the candidate cell(s), the UE may select one of the at least one candidate new serving cells as the new serving cell for the UE based on the provided information and according to a certain priority order for the provided information. For example, the certain priority order may be: 1) MBS service availability, 2) load status, 3) signal quality, where 1) is given a higher priority compared to 2), compared to 3). In an example based on this priority order, for two candidate cells that can both provide MBS service to the UE, the candidate cell with the lower load will be selected over the candidate with a higher load even when the candidate with a higher load has a better signal quality. The order may be different, for example, with the signal quality and load status interchanged so that the priority becomes: 1) MBS service availability, 2) signal quality, 3) load status.

FIG. 6 is a flowchart 600 illustrating an example cell reselection procedure for a UE in RRC_INACTIVE and in one or more MBS session(s) receiving MBS multicast data (e.g. with one or more active MBS sessions(s)), according to an embodiment of the invention.

This figure shows a UE 601, like the UE 101 of FIG. 1, in RRC_INACTIVE state, a base station 610, like the base station 110, that is the source or serving base station/gNB in the sense that it controls the cell (i.e. serving cell) where the UE 601 is currently camping, a base station 611, like the base station 111 or 112, controlling a candidate or target cell where the UE 601 may move, and the core network (5GC) 602, like the core network 102. The MBS multicast data are provided by the 5GC to the source gNB (through the bearer 640), then they are transmitted to the UE 601 (through the MBS radio bearer 641), simultaneously to the other UEs belonging to the same multicast group.

In the RRC_INACTIVE state and unlike the RRC_CONNECTED state, the UE 601 has to find and select by itself the best cell to camp on, and the core network 602 is not involved in this process. As for the step 520 in the handover procedure (described above with reference to FIG. 5), the UE 601 regularly performs measurements (step 620) on signals received at the UE 601 from the serving cell and one or more candidate cells, such as the Signal Synchronization Block (SSB) transmitted in the serving cell and in the candidate cells (also called target cells). The candidate or target cells may be neighbouring candidate or target cells to the current serving or source cell.

Once the UE 601 discovers at least one SSB with a received power that exceeds the received power of its current SSB by a certain threshold, it executes a cell reselection evaluation process at step 621. The cell reselection evaluation process is performed based on the load information and/or MBS information as discussed above and may be performed according to one or more additional criteria (i.e. criteria in addition to the availability of MBS services, and/or the load of the candidate cells) that may include: the priority of frequencies used in the candidate cells, the radio link quality. The input information for the selection (priority frequencies, MBS availability and the load) may be provided by the source gNB 610 through system information provided in a system information message 632. The measurements in step 620 provide radio link quality information for the selection. Details of an example cell reselection evaluation process performed based on the priority of frequencies used in the candidate cells and the radio link quality are given in 3GPP TS 38.304, V16.7.0, section 5.2.4.

System information is a name for all the common (non-device-specific) information that a UE needs in order to properly operate within the network. In general, the system information is carried within different System Information Blocks (SIBs), each comprising different types of system information. The various SIBs are specified in the 3GPP document TS 38.331. Delivering the SIBs is done in different ways depending on whether the UE is connected to the network or not: if the device is connected to the network, dedicated RRC signaling is used, otherwise broadcast signaling is used. Among the different SIBs, SIB1 comprises system information that a device needs to know before it can access the system (i.e. for the initial random access). SIB1 is always periodically broadcasted, and also includes information about the mapping of the remaining SIBs to system information messages, information about the transmission periodicity of each SIB and whether or not it is broadcasted. Indeed, SIBs can be periodically broadcasted as SIB1, but alternatively, these SIBs can be transmitted on demand, avoiding periodic broadcast in cells where no device is currently camping (and thus saving power). In this case, a UE has to explicitly request some SIBs transmission by means of a system information request message 631. For example, the UE sends a system information request including information for requesting load status of one or more candidate cells and/or for requesting MBS information indicating whether one or more candidate cells can support a MBS service for the UE. The system information request may include identification information (identifier(s)) for identifying each of the one or more candidate cells. The identification information for each candidate cell may include the cell ID and the base station (gNB) ID of the cell. 3GPP TS 38.413 sections 9.3.1.6 and 9.3.1.7 describes the gNB ID being included in the cell ID. The request may also include session identification information (e.g. MBS session identifier(s)) identifying the one or more MBS sessions that the UE is interested in (e.g. existing or ongoing MBS sessions (active MBS session(s))). When in RRC_INACTIVE state, the UE transmits the request message 631 through the random-access procedure. See for example, the description of a Random Access Procedure in clause 9.2.6 of 3GPP TS 38.300 (V16.8.0) and 3GPP TS 38.321, V16.7.0, section 5.1.

The other SIBs comprise system information that a device does not need to know before accessing the system. Thus, a system information message 632 may contain a SIB with a list of cells supporting the MBS service(s) and/or with the load status of cells in the neighborhood. The load status of the current serving cell may be included as well in the message 632. The load status of a candidate cell may indicate a level of a load associated with the candidate cell. The load associated with the candidate cell may be a processing load of the base station controlling the candidate cell (e.g. the load of processing resources of the base station) and/or it may be the load of the radio resources (e.g. occupied radio bandwidth) in the candidate cell. The load status may be a single bit with the value ‘1’ indicating that the processing load of the gNB controlling the cell and/or the radio bandwidth in the cell is at an overloaded level, and the value ‘0’ indicating that the processing load of the gNB and/or the radio bandwidth in the cell is at a not overloaded level or the values may be reversed with ‘0’ indicating an overloaded level and ‘1’ indicating a non-overloaded level. The load status may be a level coded on several bits (e.g. one of a plurality of levels coded on several bits).

The system information request message 631 may be a message requesting the transmission of the list of cells providing the MBS service(s). Alternatively, this request is not necessary as the information may be already known by the UE via the service announcement broadcasted by the network during the MBS session establishment procedure as discussed above with reference to FIG. 11.

The system information request message 631 may be a message requesting the transmission of load status for a particular cell or a list of cells. Therefore, such message shall include an identifier of the cell(s) the UE is requesting the load status.

The message 631 may be the RRCSystemInfoRequest message as specified in 3GPP document TS 38.331 (v16.7.0), and including the request for system information related to the ability for one cell or a list of cells to provide MBS services, and/or including the request for system information related to the load of a cell or for a list of cells.

Based on the received system information 632 and on the measurement performed at step 620, the UE 601 may select a suitable cell to move to as a new serving cell, at step 621. At step 622, the UE 601 effectively switches to the new serving cell operating on the same frequency as the previous serving cell or on a different frequency. The UE 601 can read the system information 633 (e.g. SIB1) broadcasted by the gNB 611 controlling the new serving cell.

Taking the example wireless communication system of FIG. 1, the UE 101 may have identified the candidate cells or target cells 121 and 122 as suitable cells to camp on, and both are able to provide the MBS multicast service the UE is receiving based on the MBS information received from the source or serving gNB 110. In addition, the source gNB 110 may have informed the UE 601 in load information that the load in the cell 122 is much higher than the load in the cell 121. If there is no big difference of radio signal quality between the two cells as determined by the measurements performed, the UE 101 will select the cell 121 as the new serving cell. In this case, the UE 101 has selected the new serving cell according to the following priority order: 1) MBS service availability, 2) load status, 3) signal quality, where 1) is given a higher priority compared to 2), compared to 3). The priority order may not always be in this order and could be, for example, with the signal quality and load status interchanged so that the priority becomes: 1) MBS service availability, 2) signal quality, 3) load status.

FIG. 7 is a flowchart 700 illustrating an example cell reselection procedure for a UE in RRC_INACTIVE and in one or more MBS session(s) receiving MBS multicast data (e.g. with one or more active MBS sessions), according to an embodiment of the invention.

This figure shows a UE 701, like the UE 101 in FIG. 1, in RRC_INACTIVE state, a base station 710, like the base station 110, that is the source or serving base station/gNB in the sense that it controls the cell (e.g. serving cell) where the UE is currently camping, a base station 711, like the base station 111 or 112, controlling a candidate or target cell where the UE 701 may move, and the core network (5GC) 702, like the core network 102. The MBS multicast data are provided by the 5GC to the source gNB (through the bearer 740), then they are transmitted to the UE 701 (through the MBS radio bearer 741), simultaneously to the other UEs belonging to the same multicast group.

As discussed above, in the RRC_INACTIVE state, the UE 701 has to find and select by itself the best cell to camp on, and the core network 702 is not involved in this procedure. As for the step 520 in the handover procedure (described above with reference to FIG. 5), the UE 701 regularly performs measurements (step 720) on signals received at the UE 701 from the serving cell and one or more candidate cells, such as on Signal Synchronization Block (SSB) transmitted in the serving cell and in the candidate cells (also called target cells). The candidate or target cells may be neighbouring candidate or target cells to the current serving or source cell.

Once the UE 701 discovers at least one SSB with a received power that exceeds the received power of its current SSB by a certain threshold, it executes a cell reselection evaluation process at step 721. The evaluation is performed based on criteria that may include: the priority of frequencies used in the candidate cells, the radio link quality, the availability of MBS services if the information is available. For the selection, input information related to the priority of frequencies may be provided by the source or serving gNB 710 through the system information message 732 which is regularly broadcasted or in response to a request message (not represented on the figure) sent by the UE 701. The availability of MBS services may have been received via service announcement as discussed above. Details of an example cell reselection evaluation process performed based on the priority of frequencies used in the candidate cells and the radio link quality are given in 3GPP TS 38.304, V16.7.0, section 5.2.4.

Based on the measurement performed at step 720, the UE 701 may select at least one candidate new serving cell at step 721. For example, the UE 701 selects or identifies at least one candidate new serving cell from one or more candidate cells based on the performed measurements (i.e. one or more cell(s) are identified where the measurement of signals received from the cell(s) exceed a threshold). When information concerning the priority of frequencies is provided to the UE 701 (e.g. in the received system information 732), this information may also be used to select at least one candidate new serving cell at step 721. Then, the UE 701 sends a reselection request message 731 to the source gNB 710 indicating the identifier(s) of the at least one candidate new serving cell(s). For example, the UE 701 sends a reselection request including information for requesting load status of the at least one candidate new serving cell and/or for requesting MBS information indicating whether the at least one candidate new serving cell can support a MBS service for the UE and identification information (identifier(s)) for identifying each of the at least one candidate new serving cell. The identification information for each candidate new serving cell may include the cell ID and the base station (gNB) ID of the cell. 3GPP TS 38.413 sections 9.3.1.6 and 9.3.1.7 describes the gNB ID being included in the cell ID. The reselection request may also include session identification information (e.g. MBS session identifier(s)) identifying the one or more MBS sessions that the UE is interested in (e.g. existing or ongoing MBS sessions (active MBS session(s))).

The source gNB may respond with a reselection feedback message 732 indicating for each candidate cell (e.g. for each of the at least one candidate new serving cell identified in the reselection request) the availability of the MBS service(s) and/or an indication of the load status of the candidate cell(s). The load status of the current serving cell may be included as well in the message 732. The load status of the candidate cell(s) may indicate a level of a load associated with the candidate cell. The load associated with the candidate cell may be a processing load of the base station controlling the candidate cell (e.g. the load of processing resources of the base station) and/or it may be the load of the radio resources (e.g. occupied radio bandwidth) in the candidate cell. The load status may be a single bit with the value ‘1’ indicating that the processing load of the gNB controlling the cell and/or the radio bandwidth in the cell is at an overloaded level, and the value ‘0’ indicating that the processing load of the gNB and/or the radio bandwidth in the cell is at a not overloaded level or the values may be reversed with ‘0’ indicating an overloaded status and ‘1’ indicating a non-overloaded status. The load status may be a level coded on several bits. To not send a reselection feedback message 732 may also be a way for the source gNB to indicate that there is no suitable cell among the cells identified in the reselection request message 731. In other words, when the source or serving gNB determines that all of the identified cells in the reselection request message 731 are overloaded and/or cannot support MBS service, the source or serving gNB does not send reselection feedback in response to the reselection request. The UE therefore determines that all of the identified cells in the reselection request message 731 are overloaded and/or cannot support MBS service when it does not receive a reselection feedback (e.g. within a certain time period which starts on the sending of the reselection request).

In case at least one of the candidate cells provides the MBS service(s) and is not overloaded, the UE 701 can effectively switch at step 722 to a new serving cell operating on the same frequency as the previous serving cell or on a different frequency. For instance, the new serving cell can be the cell providing the MBS service(s) with the lowest load as determined from the MBS and load information. Then, the UE 701 may read the system information 734 (e.g. SIB1) broadcasted by the gNB 711 controlling the new serving cell.

In case of none of the candidate cells identified in the reselection request message 731 is suitable (e.g. because none of the candidate cells support the MBS service(s) and/or all of the candidate cells are overloaded), the UE 701 may try to identify other candidate cell(s) at step 721 before submitting a new reselection request 731 to the source gNB 711. New measurement step 720 may be necessary as well.

According to an example, the reselection request message 731 may be the RRCSystemInfoRequest message as specified in 3GPP document TS 38.331 (v16.7.0), and including the request for system information related to the ability for a cell or a list of cells to provide MBS services, and/or including the request for system information related to the load of a cell or a list of cells. The reselection feedback message 732 may be a dedicated System Information Block (SIB).

According to another example, the reselection request message 732 may be the RRCResumeRequest message or the RRCResumeRequest1 message specified in the 3GPP document TS 38.331 (v16.7.0), amended with an information element indicating that the intention of the UE is not to switch to RRC_CONNECTED state but to perform cell reselection. For this purpose, the resumeCause information element (IE) may be set to a new value indicating the cause is cell reselection. Besides, a new information element may be introduced to indicate the target or candidate cell(s) identifier(s). The reselection feedback message 732 may be the RRCRelease message or the RRCRelease with suspend configuration message, specified in the 3GPP document TS 38.331 (v16.7.0), amended with an information element indicating the ability for a cell or a list of cells to provide MBS services, and/or including the load of a cell or a list of cells.

According to another example, the reselection feedback information may be inserted in a MAC CE (Control Element) carried in a MAC sub-header of a packet transmitted by the source gNB 710. MAC CEs are defined in the 3GPP specification TS 38.321. For instance, a dedicated field in the MAC sub-header may be reserved to indicate the ability for a cell or a list of cells to provide MBS services, and/or to indicate the load of a cell or a list of cells. This field may be reduced to one bit to indicate whether the candidate cell selected by the UE 701 is overloaded or not.

For both the examples of FIGS. 6 and 7, it may happen that the UE 601/701 cannot receive any more signals from the source gNB 610/710 due to a radio link failure. In this case, the UE 601/701 may perform the cell reselection evaluation process 621/721 without recent system information. The UE 601/701 may select and switch to a target cell, and then may read the system information from the target gNB to determine whether the target gNB supports the MBS service(s) and/or whether it is not overloaded. If the selected cell is suitable to receive the MBS service(s) and/or is not overloaded, the UE 601/701 can camp in this selected cell, otherwise it may select another one. If such information is not provided through SIBs, the UE 601/701 may send a RRCResumeRequest message or the RRCResumeRequest1 message indicating a request for cell reselection.

By executing a cell reselection process in accordance with embodiments of the invention as described with reference to FIG. 6 or FIG. 7, the UE can continue to receive the MBS multicast data after switching to a new serving cell.

FIG. 8 illustrates, using flowchart 800, a method performed at a base station for supporting cell reselection for a UE by providing information for cell reselection in accordance with embodiments of the invention. The base station may be the gNB 110 of FIG. 1 and may comprise the base station/gNB 305 of FIG. 3 with the method being performed by the processor 315. The UE is camped on a serving cell and the base station 110 performing the method is the base station controlling the serving cell and so is referred to as the serving base station.

Optionally, at step 801 the base station 110 (e.g. the serving base station) receives a request from a UE, such as UE 101. The request includes information for requesting load status of one or more candidate cells and/or for requesting MBS information indicating whether one or more candidate cells can support a MBS service for the UE. The request may include identification information (identifier(s)) for identifying each of the one or more candidate cells. The identification information for each candidate cell may include the cell ID and the base station (gNB) ID of the cell. 3GPP TS 38.413 sections 9.3.1.6 and 9.3.1.7 describes the gNB ID being included in the cell ID. The request may also include session identification information (e.g. MBS session identifier(s)) identifying the one or more MBS sessions that the UE is interested in (e.g. existing or ongoing MBS sessions (active MBS session(s))). The request may be a system information request. The system information request may be a request for a SIB to provide a list of cells supporting the MBS service(s) and/or the load status of cells in the neighborhood (it corresponds to the message 631 in the FIG. 6). Alternatively, the request sent by the UE 101 may be a reselection request such as the reselection request (message 731 in FIG. 7) as described in more detail with reference to FIG. 7, FIG. 9b and FIG. 12.

At step 802, the base station 110 obtains a load status of one or more candidate cells. For example, the base station 110 obtains the load status for the cell(s) in the neighbourhood of the serving cell. The load status of a candidate cell indicates a level of a load associated with the candidate cell. The load associated with the candidate cell may be a processing load of the base station controlling the candidate cell (e.g. the load of processing resources of the base station) and/or it may be the load of the radio resources (e.g. occupied radio bandwidth) in the candidate cell. For instance, the load status is obtained from other base stations (such as the base stations controlling neighbouring cells) or from the core network (such as core network 102 of FIG. 1). The load status may be obtained through Xn and/or NG protocol messages exchanged with other base stations (such as base stations 111, 112 of FIG. 1) or with the core network (such as core network 102 of FIG. 1). The step 802 may be performed regularly or upon a local trigger in the base station 110 (for instance when its processing load becomes above a threshold), or upon reception of a request (such as the system information request as per step 801).

The base station 110 may also obtain MBS information (optional step 803) relating to whether one or more candidate cells can support a MBS service for the UE. For example, the base station 110 obtains information indicating the ability to provide MBS service(s) for the cell(s) in the neighbourhood of the serving cell (e.g. neighbouring candidate cells). Alternatively, the base station 110 obtains information listing all of the cells that can provide or support MBS service for the UE. The information may be obtained from other base stations (such as the base stations controlling neighbouring cells) or from the core network (such as core network 102 of FIG. 1). The information may be obtained through Xn and/or NG protocol messages exchanged with other base stations (such as base stations 111, 112 of FIG. 1) or with the core network (such as core network 102 of FIG. 1). The step 803 may be performed regularly or upon a local trigger in the base station 110 (for instance when its processing load becomes above a threshold), or upon reception of a request (such as the system information request as per step 801). Steps 802 and 803 may be performed at the same time or separately.

At step 804, the base station 110 sends the obtained information. For example, the base station 110 sends the obtained information through a broadcasted SIB (e.g. periodically), or in response to a request for information received from a UE and in this case, the obtained information is sent to the requesting UE. For example, the base station 110 sends the obtained information through a SIB sent to the UE that made the request (it corresponds to the message 632 in FIG. 6 sent in response to the system request message 631). Alternatively, the request sent by the UE 101 may be a reselection request such as the reselection request as described in more detail with reference to FIG. 7, FIG. 9b, FIG. 12. In this case, the base station 110 sends a reselection feedback to the requesting UE 101 in response to the reselection request, and the reselection feedback includes the obtained information. The information sent to the UE includes load information indicating the load status of the one or more candidate cells obtained in step 802. When MBS information is also obtained (step 803), the information may also include the obtained MBS information. The load information and the MBS information may be sent in one message or separately. The MBS information may be sent as part of a MBS procedure for establishing a MBS session as discussed above with reference to FIG. 11.

FIG. 12 illustrates, using flowchart 1200, an example method performed at a base station for supporting cell reselection for a UE by providing information for cell reselection in accordance with embodiments of the invention. The base station may be the gNB 110 of FIG. 1 and may comprise the base station/gNB 305 of FIG. 3 with the method being performed by the processor 315. The UE is camped on a serving cell and the base station 110 performing the method is the base station controlling the serving cell and so is referred to as the serving base station.

At step 1201, the base station 110 receives a request for cell reselection from a UE, such as UE 101. The reselection request sent by the UE 101 includes information for requesting load status of one or more candidate cells and/or for requesting MBS information indicating whether one or more candidate cells can support a MBS service for the UE and identification information (identifier(s)) for identifying each of the one or more candidate cells for which the information is requested. The request for cell reselection received at the base station 110 may therefore include identification information with identification of a candidate cell or a list of candidate cells (it corresponds to the message 731 in the FIG. 7). At step 1202, the base station obtains MBS information relating to whether the identified one or more candidate cells can support a MBS service for the UE and/or the load information indicating the load status of the identified one or more candidate cells. For example, the base station 110 obtains information indicating the ability to provide MBS service(s) and/or the load status for the cell(s) identified in the request. This step 1202 is similar to the step 802 (and step 803) of the FIG. 8. Then, at step 1203, the base station sends the obtained information to the requesting UE (it corresponds to the message 732 in FIG. 7).

FIG. 9a illustrates, using flowchart 900, an example method performed at a UE for cell reselection in accordance with embodiments of the invention. UE may be UE 101 of FIG. 1 in the serving cell 120 controlled by serving base station 110 and may comprise the UE 205 of FIG. 2 with the method being performed by the processor 215.

At step 901, the UE 101 performs measurement on signals received at the UE from the one or more candidate cells (e.g. neighbouring cells such as cells 121, 122). Measurements may also be performed on signals received at the UE 101 from the serving cell 120. For example, the UE 101 measures one or more parameters, such as the reference signal received power (RSRP), or reference signal received quality (RSRQ), of a signal received from the candidate or serving cell. Measurements may be performed on received Signal Synchronization Block (SSB). Thus, the UE 101 performs measurement on signals in serving cell and candidate cell(s) in the neighbourhood. Optionally, at step 902 the UE 101 sends a system information request to the serving base station 110 (it corresponds to the message 631 in the FIG. 6). At step 903, the UE 101 receives from the serving base station 110 information about the ability to provide MBS service(s) (e.g. whether one or more candidate cells can support a MBS service for the UE) and/or the load status of the one or more candidate cell(s) in the neighborhood (it corresponds to the message 632 in the FIG. 6). The information may be sent by the serving base station 110 (e.g. in message 632 of FIG. 6) in response to a system information request sent by the UE or may be sent periodically by the serving base station 110. At step 904, the UE 101 executes the cell reselection evaluation process (step 621 in the FIG. 6) based on the measurement performed at step 901 and on the information received at step 903. Finally, at step 905, the UE 101 switches cell and camps on the cell selected at the step 904.

FIG. 9b illustrates, using flowchart 910, another example method performed at a UE for cell reselection in accordance with embodiments of the invention. UE may be UE 101 of FIG. 1 in the serving cell 120 controlled by serving base station 110 and may comprise the UE 205 of FIG. 2 with the method being performed by the processor 215.

At step 911, the UE 101 performs measurement on signals received at the UE from the one or more candidate cells (e.g. neighbouring cells such as cells 121, 122). Measurements may also be performed on signals received at the UE 101 from the serving cell 120. For example, the UE 101 measures one or more parameters, such as the reference signal received power (RSRP), or reference signal received quality (RSRQ), of a signal received from the candidate or serving cell. Measurements may be performed on received Signal Synchronization Block (SSB). Thus, the UE 101 performs measurement on signals in serving cell and candidate cell(s) in the neighbourhood. At step 912, the UE 101 executes the cell reselection evaluation process (step 721 in the FIG. 7) based on the measurement performed at step 911. At step 913, the UE 101 sends a cell reselection request to the serving base station 110 with identification of a cell or a list of cells selected at step 912 (it corresponds to the message 731 in the FIG. 7). The reselection request sent by the UE 101 includes information for requesting load status of one or more candidate cells and/or for requesting MBS information indicating whether one or more candidate cells can support a MBS service for the UE and identification information (identifier(s)) for identifying each of the one or more candidate cells for which the MBS and load information is requested. At step 914, the UE 101 receives from the serving base station 110 a cell reselection feedback including information indicating the ability to provide MBS service(s) and/or the load status of the identified cell(s) (it corresponds to the message 732 in the FIG. 7). In other words, the reselection feedback received at the UE 101 from the serving base station 110 includes MBS information relating to whether the identified one or more candidate cells can support a MBS service for the UE and/or load information indicating the load status of the identified one or more candidate cells. At step 915, the UE 101 selects a cell (for instance the one having the lowest load if several cells are suitable), and switches to this new cell to camp on.

It can be noted that the flowcharts of FIGS. 6 and 7 may be merged: the messages 731 and 732 may be exchanged after the execution of step 621 in the FIG. 6. Consequently, the flowcharts of FIGS. 8 and 12 may be merged: the steps 1201, 1202, 1203 may be executed after the steps 801, 802, 803, 804. Also, the flowcharts of FIGS. 9a and 9b may be merged: the steps 913, 914 may be executed after the step 904 and before the step 905). In the case where the cell reselection evaluation process of step 904 is not performed immediately after the information is received in step 903, the information may then be out of date when the cell reselection evaluation process is performed in step 904. By sending a cell reselection request (step 913) and waiting to receive a response (e.g. receiving the cell reselection feedback in step 914) after step 903 and before performing a cell reselection evaluation process in step 904, this ensures that when the cell reselection evaluation process is performed at step 904, the information used by the UE 101 is up to date.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1-20. (canceled)

21. A method for reselecting, by a User Equipment (UE), a new serving cell of a wireless communication system, the method at the UE comprising:
receiving, from a serving base station as part of a Multicast Broadcast Service, MBS, procedure for receiving a multicast MBS session, multicast MBS information for one or more candidate cells, the multicast MBS information for a candidate cell indicating whether the respective candidate cell can support a multicast MBS service for the UE;
selecting one of the one or more candidate cells as a new serving cell for the UE based on the received multicast MBS information.

22. The method of claim 21, wherein the UE is participating in one or more multicast Multicast Broadcast Service, MBS, sessions.

23. The method of claim 21, wherein the UE is operating in a RRC_INACTIVE state.

24. The method of claim 21, further comprising in response to selecting the one of the one or more candidate cells as the new serving cell, switching to the new serving cell.

25-36. (canceled)

37. Apparatus for a User Equipment (UE), for reselecting a new serving cell of a wireless communication system, the apparatus comprising:
one or more processing units configured to:
receive, from a serving base station as part of a Multicast Broadcast Service, MBS, procedure for receiving a multicast MBS session, multicast MBS information for one or more candidate cells, the multicast MBS information for a candidate cell indicating whether the respective candidate cell can support a multicast MBS service for the UE;
select one of the one or more candidate cells as a new serving cell for the UE based on the received multicast MBS information.

38-43. (canceled)

44. A non-transitory computer-readable storage medium carrying a computer program comprising instructions which, when the program is executed by a computer of a User Equipment (UE), the UE operating in a non-connected RRC state with one or more active MBS multicast sessions, cause the computer to:
receive, from a serving base station as part of a Multicast Broadcast Service, MBS, procedure for receiving a multicast MBS session, multicast MBS information for one or more candidate cells, the multicast MBS information for a candidate cell indicating whether the respective candidate cell can support a multicast MBS service for the UE;
select one of the one or more candidate cells as a new serving cell for the UE based on the received multicast MBS information.

45. The method of claim 21, wherein receiving comprises receiving, from a serving base station as part of a Multicast Broadcast Service, MBS, procedure for establishing a multicast MBS session, the multicast MBS information for one or more candidate cells.

46. The method of claim 21, wherein the MBS information includes a list of cells that can provide one or more multicast MBS services for the UE.

47. The apparatus of claim 37, wherein the UE is participating in one or more multicast Multicast Broadcast Service, MBS, sessions.

48. The apparatus of claim 37, wherein the UE is operating in a RRC_INACTIVE state.

49. The apparatus of claim 37, wherein the one or more processing units are further configured to in response to selecting the one of the one or more candidate cells as the new serving cell, switch to the new serving cell.

50. The apparatus of claim 37, wherein the one or more processing units are configured to receive multicast MBS information by receiving, from a serving base station as part of a Multicast Broadcast Service, MBS, procedure for establishing a multicast MBS session, the multicast MBS information for one or more candidate cells.

51. The apparatus of claim 37, wherein the multicast MBS information includes a list of cells that can provide one or more multicast MBS services for the UE.
